(19) United States
(12) Patent Application Publication
(10) Pub. No.: US 2021/0263401 A1
(43) Pub. Date: Aug. 26, 2021

(54) LIGHT SOURCE APPARATUS, ILLUMINATOR, AND PROJECTOR

(71) Applicant: SEIKO EPSON CORPORATION, Tokyo (JP)

(72) Inventor: Koichi AKIYAMA, Azumino-shi (JP)

(21) Appl. No.: 17/183,423

(22) Filed: Feb. 24, 2021

(30) Foreign Application Priority Data
Feb. 24, 2020 (JP) 2020-028895

(51) Int. Cl. G03B 21/20; H04N 9/31

(52) U.S. Cl. CPC G03B 21/204; G03B 21/208; H04N 9/3164; H04N 9/3161; G03B 21/2013

(57) ABSTRACT

A light source apparatus according to an aspect of the present disclosure includes a light emitter that outputs light, a multi-lens array having a first surface on which the light outputted from the light emitter is incident and a second surface via which the light incident via the first surface exits, a light transmissive member having a third surface on which the light that exits via the second surface is incident and a fourth surface via which the light incident via the third surface exits, and a seal member that seals the space between the second surface and the third surface, and the multi-lens array forms a focal point which is located on the light exiting side with respect to the first surface and where the light that enters the multi-lens array is focused.

The present application is based on, and claims priority from JP Application Serial Number 2020-028895, filed Feb. 24, 2020, the disclosure of which is hereby incorporated by reference herein in its entirety.

### BACKGROUND

### 1. Technical Field

The present disclosure relates to a light source apparatus, an illuminator, and a projector.

### 2. Related Art

In the field of projectors, a light source apparatus using fluorescence emitted from a phosphor when the phosphor is irradiated with excitation light outputted from a laser light source has been proposed. In a source apparatus of this type, a multi-lens array is used in some cases to homogenize the illuminance distribution of the excitation light on the phosphor.

JP-A-2019-66625 discloses an optical engine that includes a lip source apparatus including a plurality of semiconductor lasers and a lens array having a plurality of collimation lenses, an enclosure having a light passage opening, and a seal member that connects the lens array to the enclosure, with the seal member disposed and compressed between the lens array and the enclosure. JP-A-2019-66625 describes that the optical engine, in which the lens array is connected via the seal member to the enclosure, can suppress adhesion of dust and other undesirable substances to the lens array.

In the optical engine disclosed in JP-A-2019-66625, the gap between the lens array and the enclosure is closed by the seal member, but on the other hand, an end of the enclosure that is the end opposite the side where the light passage opening is provided is open and therefore communicates with the space outside the enclosure. Dust and other undesirable substances can therefore undesirably enter the enclosure and adhere to the lens array.

### SUMMARY

To solve the problem described above, a light source apparatus according to an aspect of the present disclosure includes a light emitter that outputs light, a multi-lens array having a first surface on which the light outputted from the light emitter is incident and a second surface via which the light incident via the first surface exits, a light transmissive member having a third surface on which the light that exits via the second surface is incident and a fourth surface via which the light incident via the third surface exits, and a seal member that seals a space between the second surface and the third surface, and the multi-lens array forms a focal point which is located on a light exiting side with respect to the first surface and where the light that enters the multi-lens array is focused.

An illuminator according to another aspect of the present disclosure includes the light source apparatus according to the aspect of the present disclosure, a light collector that receives light that exits out of the transmissive member and collects the received light, and a diffuser that receives the light collected by the light collector.

A projector according to another aspect of the present disclosure includes the light source apparatus according to the aspect of the present disclosure, a light modulator that modulates light outputted from the light source apparatus in accordance with image information to form image light, and a projection optical apparatus that projects the image light outputted from the light modulator.

### BRIEF DESCRIPTION OF THE DRAWINGS

FIG. 1 is a schematic configuration diagram of a projector according to an embodiment of the present disclosure.

FIG. 2 is a schematic configuration diagram of an illuminator according to the embodiment of the present disclosure.

FIG. 3 is a cross-sectional view of a homogenizing system.

### DESCRIPTION OF EXEMPLARY EMBODIMENTS

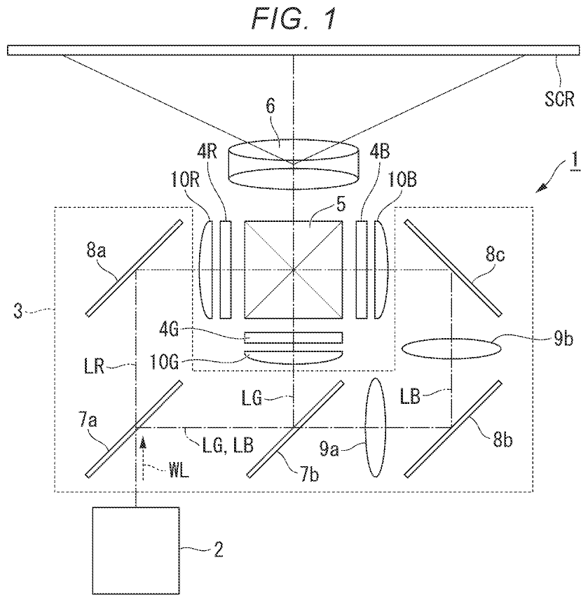

An embodiment of the present disclosure will be described below with reference to FIGS. 1 to 3.

In the following drawings, components are drawn at different dimensional scales in some cases for clarity of each of the components.

An example of a projector according to the present embodiment will be described.

FIG. 1 shows a schematic configuration of a projector 1 according to the present embodiment.

The projector 1 according to the present embodiment is a projection-type image display apparatus that displays color video images on a screen SCR, as shown in FIG. 1. The projector 1 includes an illuminator 2, a color separation system 3, light modulators 4R, 4G, and 4B, a light combining system 5, and a projection optical apparatus 6. The configuration of the illuminator 2 will be described later in detail.

The color separation system 3 includes a first dichroic mirror 7a, a second dichroic mirror 7b, reflection mirrors 8a, 8b, and 8c, and relay lenses 9a and 9b. The color separation system 3 separates illumination light WL outputted from the illuminator 2 into red light LR, green light LG, and blue light LB, guides the red light LR to the light modulator 4R, guides the green light LG to the light modulator 4G, and guides the blue light LB to the light modulator 4B.

A field lens 10R is disposed between the color separation system 3 and the light modulator 4R, substantially parallelizes incident light, and causes the resultant light to travel toward the light modulator 4R. A field lens 10G is disposed between the color separation system 3 and the light modulator 4G, substantially parallelizes incident light, and causes the resultant light to travel toward the light modulator 4G. A field lens 10B is disposed between the color separation system 3 and the light modulator 43, substantially parallelizes incident light, and causes the resultant light to travel toward the light modulator 45.

The first dichroic mirror 7a transmits a red light component and reflects a green light component and a blue light component. The second dichroic mirror 7b reflects the green light component and transmits the blue light component. The reflection mirror 8a reflects the red light component. The reflection mirrors 8b and 8c reflect the blue light component.

The red light LR having passed through the first dichroic mirror 7a is reflected off the reflection mirror 8a, passes through the field lens 10R, and is incident on an image formation area of the light modulator 4R for red light. The green light LG reflected off the first dichroic mirror 7a is further reflected off the second dichroic mirror 7b, passes through the field lens 10G, and is incident on an image formation area of the light modulator 4G for green light. The blue light LB having passed through the second dichroic mirror 7b travels via the relay lens 9a, the light-incident-side ref lection mirror 8b, the relay lens 9b, the light-exiting-side reflection mirror 8c, and the field lens 10B and is incident on an image formation area of the light modulator 4B for blue light.

The light modulators 4R, 4G, and 4B each modulate the color light incident thereon in accordance with image information to form image light. The light modulators 4R, 4G, and 4B are each formed of a liquid crystal light valve. Although not shown, a light-incident-side polarizer is disposed on the light incident side of each of the light modulators 4R, 4G, and 4B. A light-exiting-side polarizer is disposed on the light exiting side of each of the light modulators 4R, 4G, and 4B.

The light combining system 5 combines the image light outputted from the light modulator 4R, the image light outputted from the light modulator 4G, and the image light outputted from the light modulator 4B with one another to form full-color image light. The light combining system 5 is formed of a cross dichroic prism formed of four right angled prisms bonded to each other and having a substantially square shape in a plan view. Dielectric multilayer films are formed along the substantially X-letter-shaped interfaces between the right angled prisms bonded to each other.

The image light having exited out of the light combining system 5 is enlarged and projected onto the screen SCR by the projection optical apparatus 6 to form an image. That is, the projection optical apparatus 6 projects the image light outputted from the light modulator 4R, the image light outputted from the light modulator 4G, and the image light outputted from the light modulator 4B. The projection optical apparatus 6 is formed of a plurality of projection lenses.

An example of the illuminator 2 according to the present embodiment will be described.

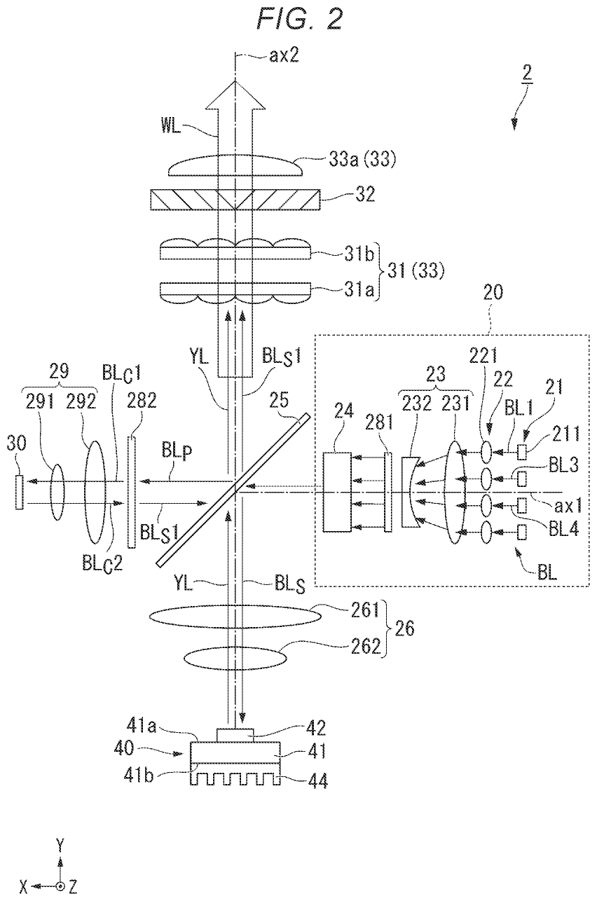

FIG. 2 shows a schematic configuration of the illuminator 2.

The illuminator 2 includes a light source apparatus 20, a polarization separator 25, a first light collection system 26, a wavelength converter 40, a second retardation film 282, a second light collection system 29, a diffusive reflector 30, an optical integration system 31, a polarization converter 32, and a superimposing lens 33a, as shown in FIG. 2. The optical integration system 31 and the superimposing lens 33a form a superimposing system 33.

The light source apparatus 20 includes a light source section 21, a collimator system 22, an a focal system 23, a first retardation film 281, and a homogenizing system 24.

In FIG. 2 used in the following description, an XYZ orthogonal coordinate system is used, and the axes thereof are defined as follows: An axis X is an axis parallel to the chief ray of a light beam flux BL outputted from the light source section 21; an axis Y is an axis parallel to the chief ray of fluorescence YL emitted from the wavelength converter 40; and an axis Z is an axis perpendicular to the axes X and Y.

The light source section 21, the collimator system 22, the afocal system 23, the first retardation film 281, the homogenizing system 24, the polarization separator 25, the second retardation film 282, the second light collection system 29, and the diffusive reflector 30 are sequentially arranged along an optical axis ax1. The wavelength converter 40, the first light collection system 26, the polarization separator 25, the optical integration system 31, the polarization converter 32, and the superimposing lens 33a are sequentially arranged along an optical axis ax2. The optical axes ax1 and ax2 are present in the same plane and perpendicular to each other. The optical axis ax1 is an axis along the chief ray of the light beam flux BL, and the optical axis ax2 is an axis along the chief ray of the fluorescence YL.

The light source section 21 includes a plurality of light emitters 211, each of which outputs excitation light. The plurality of light emitters 211 are arranged in an array in a plane perpendicular to the optical axis ax1. In the present embodiment, the light source section 21 has a configuration in which four light source units each formed of four light emitters 211 arranged in a row along the axis Y are arranged along the axis Z, which is perpendicular to the axis Y, along which the four light emitters 211 are arranged. That is, the light source section 21 has a configuration in which 16 light emitters 211 are arranged in an array formed of four rows and four columns. The number and arrangement of light emitters 211 are not limited to those described above.

The light emitters 211 are each formed of a laser device that outputs a laser beam BL1. The laser device is formed of, for example, a semiconductor laser and outputs a blue light beam that belongs to a first wavelength band, specifically, a laser beam BL1 that belongs to a first wavelength band having a peak wavelength of, for example, 460 nm. The light source section 21 therefore outputs the light beam flux BL containing a plurality of laser beams BL1. The laser beams BL1 in the present embodiment correspond to the light in the appended claims.

The light beam flux BL outputted from the light source section 21 enters the collimator system 22. The collimator system 22 converts the light beam flux BL outputted from the light source section 21 into parallelized light. The collimator system 22 is formed of a plurality of collimator lenses 221 arranged in an array. The collimator lenses 221 are each disposed in the position where the laser beam BL1 outputted from the corresponding light emitter 211 is incident.

The light beam flux BL having passed through the collimator system 22 enters the afocal system 23. The afocal system 23 adjusts the diameter, that is, the thickness of the light beam flux BL. The afocal system 23 is formed of a convex lens 231 and a concave lens 232.

The light beam flux BL1 having passed through the afocal system 23 enters the first retardation film 281. The first retardation film 281 is formed, for example, of a half wave plate configured to be rotatable. The light beam flux BL immediately after outputted from the light source section 21 is linearly polarized light having a predetermined polarization direction. Appropriately setting the angle of rotation of the first retardation film 281 allows the light beam flux BL passing through the first retardation film 281 to be converted to a light beam flux BL containing an S-polarized component and a P-polarized component with respect to the polarization separator 25 mixed with each other at a predetermined ratio. The ratio between the S-polarized component and the P-polarized component can be changed by changing the angle of rotation of the first retardation film 281.

The light beam flux BL having passed through the first retardation film 281 enters the homogenizing system 24. The homogenizing system 24 substantially homogenizes the illuminance distribution at the wave length converter 40 and the diffusive reflector 30 each as an illumination receiving area that receives the light beam flux BL to form what is called a top-hat distribution. The configuration of the homogenizing system 24 will be described later in detail.

The light beam flux BL having exited out of the homogenizing system 24 and containing the S-polarized and P-polarized components enters the polarization separator 25. The polarization separator 25 is formed, for example, of a polarization beam splitter having wavelength selectivity. The polarization separator 25 inclines by 45° with respect to the optical axes ax1 and ax2.

The polarization separator 25 has a polarization separation function of separating the light beam flux BL into a light beam flux BLs, which is formed of the S-polarized component with respect to the polarization separator 25, and a light beam flux BLp, which is formed of the P-polarized component with respect to the polarization separator 25. Specifically, the polarization separator 25 reflects the light beam flux BLs, which is formed of the S-polarized component, and transmits the light beam flux BLp, which is formed of the P-polarized component The polarization separator 25 further has a color separation function of transmitting a yellow light component, which belongs to a wavelength band different from the wavelength band to which the blue light beam flux BL belongs, irrespective of the polarization state of the yellow light component in addition to the polarization separation function.

The S-polarized light beam flux BLs reflected off the polarization separator 25 enters the first light collection system 26. The first light collection system 26, which receives the laser beams BL1 that exit out of a light transmissive member 52, which will be described later, causes the light beam flux BLs to converge toward the wavelength converter 40. The first light collection system 26 is formed of a first lens 261 and a second lens 262. The first lens 261 and the second lens 262 are each formed of a convex lens. The light beam flux BLs having exited out of the first light collection system 26 enters in the form of a collected light flux the wavelength converter 40. The first lens 261 and the second lens 262 in the present embodiment correspond to the light collector in the appended claims.

The wavelength converter 40 includes a base 41, a wavelength conversion layer 42, and a heat sink 44. In the present embodiment, the wavelength conversion layer 42 is formed of a phosphor. In the present embodiment, a fixed wavelength converter configured not to be rotatable with no motor or any other drive source is used as the wavelength converter 40. The laser beams BL1 collected by the first lens 261 and the second lens 262 enter the wavelength converter 40. The wavelength converter 40 in the present embodiment corresponds to the diffuser in the appended claims.

The wavelength conversion layer 42 contains a ceramic phosphor that converts the light beam flux BLs into the fluorescence YL, which belongs to a second wavelength band different from the first wavelength band. The second wavelength band ranges, for example, from 490 to 750 nm, and the fluorescence YL is yellow light containing the green light component and the red light component. The wavelength conversion layer 42 contains, for example, an yttrium-aluminum-garnet-based (YAG-based) phosphor. Consider YAG:Ce, which contains cerium (Ce) as an activator by way of example, and the wavelength conversion layer 42 can be made, for example, of a material produced by mixing raw powder materials containing Y₂O₃, Al₂O₃, CeO₃, and other constituent elements with one another and causes the mixture to undergo a solid-phase reaction, Y—Al—O amorphous particles produced by using a coprecipitation method, a sol-gel method, or any other wet method, or YAG particles produced by using a spray-drying method, a flame-based thermal decomposition method, or a thermal plasma method or any other gas-phase method.

The wavelength conversion layer 42 is bonded to a first surface 41a of the base 41 via a bonding material (not shown). The bonding material is, for example, a nano-silver sintered metal material. The base 41 is made of a metal material having high light reflectance, for example, aluminum and silver. The first surface 41a of the base 41 reflects the light that travels in the interior of the wavelength conversion layer 42. A reflection layer may further be provided between the first surface 41a of the base 41 and the wavelength conversion layer 42.

The heat sink 44 includes a plurality of fins. The heat sink 44 is provided on a second surface 41b of the base 41. The heat sink 44 is fixed to the base 41 by means, for example, of metal bonding. In the wavelength converter 40, dissipation of heat from the wavelength conversion layer 42 via the heat sink 44 can suppress thermal degradation of the wavelength conversion layer 42.

The yellow fluorescence YL produced by the wavelength converter 40 is parallelized by the first light collection system 26 and then enters the polarization separator 25. Since the polarization separator 25 is characterized in that it transmits the yellow light component irrespective of the polarization state thereof, as described above, the fluorescence YL passes through the polarization separator 25.

On the other hand, the P-polarized light beam flux BLp having exited out of the polarization separator 25 enters the second retardation film 282. The second retardation film 282 is formed of a quarter wave plate disposed on the optical path between the polarization separator 25 and the diffusive reflector 30. The P-polarized light beam flux BLp having exited out of the polarization separator 25 is converted by the second retardation film 282, for example, into right-handed circularly polarized blue light beam flux BLc1, which then enters the second light collection system 29.

The second light collection system 29 is formed of a first lens 291 and a second lens 292. The first lens 291 and the second lens 292 are each formed of a convex lens. The second light collection system 29 causes the blue light beam flux BLc1 to enter in the form of a collected light flux the diffusive reflector 30.

The diffusive reflector 30 is disposed on the optical path of the light beam flux BLp having exited out of the polarization separator 25. The diffusive reflector 30 diffusively reflects the blue light beam flux BLc1 having exited out of the second light collection system 29 toward the polarization separator 25. The diffusive reflector 30 desirably reflects the blue light beam flux BLc1 with an angular distribution approximate to a Lambertian diffusion scheme but does not disturb the polarization state of the blue light beam flux BLc1. The diffusive reflector 30 in the present embodiment corresponds to the diffuser in the appended claims.

The light diffusively reflected off the diffusive reflector 30 is hereinafter referred to as blue light beam flux BLc2. In the present embodiment, diffusively reflecting the blue light bean flux BLc1 results in blue light bean flux BLc2 having a substantially uniform illuminance distribution. For example, the diffusive reflector 30 diffusively reflects the right-handed circularly polarized blue light beam flux BLc1 and converts into a left-handed circularly polarized blue light beam flux BLc2.

The blue light bean flux BLc2 is converted by the second light collection system 29 into a parallelized light beam flux and then enters the second retardation film 282 again. The left-handed circularly polarized blue light beam flux BLc2 is converted by the second retardation film 282 into an S-polarized blue light beam flux BLs1. The S-polarized blue light beam flux BLs1 is reflected off the polarization separator 25 toward the optical integration system 31.

The blue light beam flux BLs1 is thus combined with the fluorescence YL having passed through the polarization separator 25, and the combined light is used as the illumination light WL. That is, the blue light beam flux BLs1 and the fluorescence YL exit out of the polarization separator 25 in the same direction to form white illumination light WL, which is the combination of the blue light beam flux BLs1 and the yellow fluorescence YL.

The illumination light WL exits toward the optical integration system 31. The optical integration system 31 is formed of a first lens array 31a and a second lens array 31b. The first lens array 31a and the second lens array 31b are each formed of a plurality of lenses arranged in an array.

The illumination light WL having passed through the optical integration system 31 enters the polarization converter 32. The polarization converter 32 includes polarization separation films and retardation films that are not shown. The polarization converter 32 converts the illumination light WL containing the non-polarized fluorescence YL into linearly polarized light to be incident on the light modulators 4R, 4G, and 4B.

The illumination light WL having passed through the polarization converter 32 enters the superimposing lens 33a. The superimposing lens 33a cooperates with the optical integration system 31 to homogenize the illuminance distribution of the illumination light WL in the illumination receiving areas. The illuminator 2 thus produces the illumination light WL.

The configuration of the homogenizing system 24 will be described below.

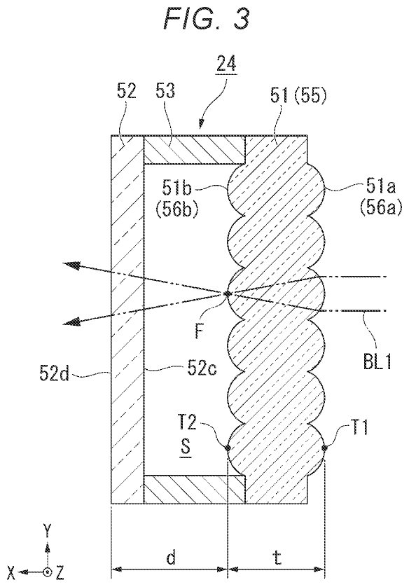

FIG. 3 is a cross-sectional view of the homogenizing system 24 taken along a sectioning plane parallel to the plane XY. FIG. 3 shows only one laser beam BL1.

The homogenizing system 24 includes a multi-lens array 51, a light transmissive member 52, and a seal member 53, as shown in FIG. 3.

The multi-lens array 51 has a first surface 51a, on which the laser beam BL1 outputted from a light emitter 211 of the light source section 21 is incident, and a second surface 51b, via which the laser beam BL1 incident via the first surface 51a exits. In the present embodiment, the multi-lens array 51 is formed of a base 55 having the first surface 51a and the second surface 51b. That is, the two surfaces of the base 55 are defined as follows: the surface facing the first retardation film 281 shown in FIG. 2 is the first surface 51a; and the surface facing the light transmissive member 52 is the second surface 51b.

In the multi-lens array 51, the first surface 51a is provided with a first multi-lens surface 56a, and the second surface 51b is provided with a second multi-lens surface 56b. The first multi-lens surface 56a and the second multi-lens surface 56b each have a configuration in which a plurality of convex lens surfaces are arranged in an array. The multi-lens array 51 is made of a light transmissive material, for example, glass, quartz, and sapphire. The multi-lens array 51 forms focal points F, which are located on the light exiting side with respect to the first surface 51a and at which the laser beams BL1 incident on the multi-lens array 51 are focused. Specifically, the multi-lens array 51 forms the focal points F on the second surface 51b.

The light transmissive member 52 has a third surface 52c, on which the laser beams BL1 that exit via the second surface 51b of the multi-lens array 51 are incident, and a fourth surface 52b, via which the light incident via the third surface 52c exits. The light transmissive member 52 is formed of a flat plate so disposed as to face the second surface 51b of the multi-lens array 51. The light transmissive member 52 is made of a light transmissive material, for example, glass, quartz, and sapphire.

The seal member 53 is provided between the second surface 51b of the multi-lens array 51 and the third surface 52c of the light transmissive member 52 and seals a space 3 between the second surface 51b and the third surface 52c. The seal member 53 is formed of a frame-shaped member having an opening 53h, through which the laser beams BL1 pass. The seal member 53 may be made of a light transmissive material, for example, glass, quartz, and sapphire, as the multi-lens array 51 and the light transmissive member 52 are, or may be made of another material, an inorganic or metal material.

The space S between the second surface 51b and the third surface 52c may be filled with clean air containing no dust or other types of foreign matter or may be filled with an inert gas, such as nitrogen and argon. The space S between the second surface 51b and the third surface 52c may be formed of a reduced pressure atmosphere having pressure lower than the atmospheric pressure.

The distance between a vertex T1 of one convex lens of the first multi-lens surface 56a of the multi-lens array 51 and a vertex T2 of one convex lens of the second multi-lens surface 56b of the multi-lens array 51 is defined as a thickness t of the multi-lens array 51, and the distance between the vertex T2 of the second multi-lens surface 56b and the fourth surface 52d of the light transmissive member 52 is defined as a distance d. The distance d between the multi-lens array 51 and the light transmissive member 52 is desirably substantially equal to the thickness t of the multi-lens array 51.

The light transmissive member 52 and the seal member 53 may be bonded to each other by means of optical contact. The multi-lens array 51 and the seal member 53 may also be bonded to each other by means of optical contact. The optical contact is a bonding technology using the following phenomenon: Two member surfaces to be bonded to each other are precisely polished so that the molecules of the surfaces are unstable, and the surfaces are then caused to come into intimate contact with each other so that the interaction between the molecules of the surfaces achieves stable contact. When the light transmissive member 52 and the seal member 53 are bonded to each other by means of optical contact, and so are the multi-lens array 51 and the seal member 53, the multi-lens array 51, the light transmissive member 52, and the seal member 53 are desirably made of the same material, particularly, made of quartz.

The light transmissive member 52 and the seal member 53 may instead be bonded to each other via a plasma polymerization film. Further, the multi-lens array 51 and the seal member 53 may be bonded to each other via a plasma polymerization film formed on each of the multi-lens array 51 and the seal member 53. The bonding described above is referred to as what is called glassLike/GlueLess (GL). The material of the plasma polymerization film may be a material having a siloxane bond and including a leaving group formed of an Si skeleton and an organic group that bonds to the Si skeleton, for example, a polymer having a siloxane bond, such as polyorganosiloxane. The plasma polymerization films may be made of the same material having a siloxane bond or different materials.

The plasma polymerization films are each characterized in that the film is activated by energy given, for example, by plasma radiation to exhibit adhesiveness. The plasma polymerization film can therefore chemically bond the light transmissive member 52 and the seal member 53 to each other with use of no adhesive or any other substance but by using the adhesiveness achieved by the energy radiation. Two layers of the plasma polymerization films have bonding interfaces chemically bonded to each other. Since some of the methyl groups bonded to each other by means of the siloxane bond are cut in the process of activating the plasma polymerization films, the content of the methyl groups contained in the bonding interfaces is smaller than that of the methyl groups contained in each of the plasma polymerization films. The two layers of the plasma polymerization films with the bonding interfaces therebetween come into very intimate contact with each other. The light transmissive member 52 and the seal member 53 are therefore bonded to each other via the plasma polymerization films.

Instead, the light transmissive member 52 and the seal member 53 may be bonded to each other via an adhesive containing no volatile component. Similarly, the multi-lens array 51 and the seal member 53 may be bonded to each other via an adhesive containing no volatile component. The bonding between the light transmissive member 52 and the seal member 53 and the bonding between the multi-lens array 51 and the seal member 53 may be performed by using the combination of two of the three bonding methods described above, that is, the bonding by means of optical contact, the bonding via a plasma polymerization film, and the bonding via an adhesive containing no volatile component.

When an illuminator that irradiates a wavelength converter with laser light as excitation light to produce fluorescence, as in the present embodiment, is used for a long period of time a decreases in the amount of light outputted from the illuminator and other problems occur in some cases. The present inventor has investigated causes of the decrease in the amount of light and found that particulate foreign matter adheres to the second surface, that is, the light exiting surface of the multi-lens array that forms the homogenizing optical system. The particulates are believed to be, for example, organic substances resulting from an outgas, such as an adhesive used in the enclosure of the light source apparatus.

The present inventor has conducted advanced analysis and found that the foreign matter adhesion does not occur very often in a light source apparatus using a discharge lamp, a light emitting diode, or any other light emitter but frequently occurs in a light source apparatus using a laser light source. The analysis further shows that no foreign matter adheres to the first surface, that is, the light incident surface of the multi-lens array but foreign matter adheres in a discretely distributed manner to the second surface, that is, the light exiting surface of the multi-lens array. The light that enters the multi-lens array is focused on the second surface of the multi-lens array, and a plurality of focal points are discretely formed. The present inventor has speculated in consideration of the facts described above that an optical dust collection effect occurs at the focal points, where the optical density of the radiated light is particularly high, and in the vicinity of the focal points on the surfaces of an optical element used in the light source apparatus, and that particulates are attracted to the focal points and in the vicinity thereof. The optical dust collection effect is also called an optical tweezer effect.

In view of the findings described above, the present inventor has conceived of a configuration in which the light transparent member is so disposed as to face the second surface of the multi-lens array and the space between the multi-lens array and the light transparent member is sealed with the seal member, and the optical dust collection effect can be suppressed and therefore adhesion of foreign matter can be suppressed. That is, in the homogenizing system 24 in the present embodiment, the space S between the multi-lens array 51 and the light transmissive member 52 is sealed with the seal member 53, and the space 5 is filled, for example, with clean air, an inert gas, or a reduced pressure atmosphere, whereby adhesion of foreign matter to the second surface 51b of the multi-lens array 51 can be suppressed.

The fourth surface 52d of the light transmissive member 52 is in contact with outside air, so that foreign matter can undesirably float in the vicinity of the fourth surface 52d of the light transmissive member 52. However, since the fourth surface 52d of the light transmissive member 52 is separate by the distance d from the second surface 51b of the multi-lens array 51, the laser beams BL1 form the focal points F on the second surface 51b of the multi-lens array 51 and then pass in the form of spread beams through the fourth surface 52d of the light transmissive member 52. The optical density of the laser beams BL1 on the fourth surface 52d of the light transmissive member 52 is therefore sufficiently lower than the optical density on the second surface 51b of the multi-lens array 51, whereby the optical dust collection effect can be suppressed. As a result, adhesion of foreign matter to the fourth surface 52d of the light transmissive member 52 can also be suppressed.

In particular, when the distance d between the multi-lens array 51 and the light transmissive member 52 is equal to the thickness t of the multi-lens array 51, the optical intensity distribution on the fourth surface 52d of the light transmissive member 52 is the same as the optical intensity distribution on the first surface 51a of the multi-lens array 51. Since the present inventor has ascertained that no foreign matter adheres to the first surface 51a of the multi-lens array 51, it is believed that no foreign matter adheres also to the fourth surface 52d of the light transmissive member 52.

### Effects of the Present Embodiment

The light source apparatus 20 according to the present embodiment provides the effects below.

The light source apparatus 20 according to the present embodiment includes the light emitters 211, which output the laser beams BL1, the multi-lens array 51, which has the first surface 51a, on which the laser beams BL1 outputted from the light emitters 211 are incident, and the second surface 51b, via which the laser beams BL1 incident via the first surface 51a exit, the light transmissive member 52, which has the third surface 52c, on which the laser beams BL1 that exit via the second surface 51b are incident, and the fourth surface 52d, via which the laser beams BL1 incident via the third surface 52c exit, and the seal member 53, which seals the space S between the second surface 51b and the third surface 52d, and the multi-lens array 51 forms the focal points F, on the light exiting side with respect to the first surface 51a, where the laser beams BL1 having entered the multi-lens array 51 are focused.

The configuration described above, in which the space S between the multi-lens array 51 and the light transmissive member 52 is sealed with the seal member 53, can suppress adhesion of foreign matter to the second surface 51b of the multi-lens array 51 and further suppress adhesion of foreign matter to the fourth surface 52d of the light transmissive member 52 because the optical density on the fourth surface 52d of the light transmissive member 52 is lower than the optical density on the second surface 51b of the multi-lens array 51.

In the light source apparatus 20 according to the present embodiment, the multi-lens array 51 is formed of the base 55 having the first surface 51a and the second surface 51b, the first surface 51a is provided with the first multi-lens surface 56a, and the second surface 51b is provided with the second multi-lens surface 56b.

The configuration described above can suppress adhesion of foreign matter to the homogenizing optical system 24 and reduce the size of the homogenizing optical system 24 even when the integrated multi-lens array 51, to which foreign matter is likely to adhere, is employed, as compared with a multi-lens array having the first multi-lens surface 56a and the second multi-lens surface 56b formed of separate members.

In the light source apparatus 20 according to the present embodiment, when the light transmissive member 52 and the seal member 53 are bonded to each other by means of optical contact, no bonding material for bonding the light transmissive member 52 and the seal member 53 to each other is required, whereby generation of foreign matter resulting, for example, from a volatile component of the bonding material can be suppressed.

In the light source apparatus 20 according to the present embodiment, when the multi-lens array 51 and the seal member 53 are bonded to each other by means of optical contact, no bonding material for bonding the multi-lens array 51 and the seal member 53 to each other is required, whereby generation of foreign matter resulting, for example, from a volatile component of the bonding material can be suppressed.

In the light source apparatus 20 according to the present embodiment, when the multi-lens array 51, the light transmissive member 52, and the seal member 53 are each made of quarts, the optical-contact-based bonding described above is readily performed, whereby predetermined bonding strength is achieved.

In the light source apparatus 20 according to the present embodiment, when the light transmissive member 52 and the seal member 53 are bonded to each other via a plasma polymerization film, the light transmissive member 52 and the seal member 53 are bonded to each other via a glassy substance, whereby generation of foreign matter resulting, for example, from a volatile component of the bonding material can be suppressed.

In the light source apparatus 20 according to the present embodiment, when the multi-lens array 51 and the seal member 53 are bonded to each other via a plasma polymerization film, the multi-lens array 51 and the seal member 53 are bonded to each other via a glassy substance, whereby generation of foreign matter resulting, for example, from a volatile component of the bonding material can be suppressed.

The light source apparatus 20 according to the present embodiment, in which the light emitters 211 are each formed of a laser device, uses the laser beams BL1, each of which has an optical density higher than that of a light emitting diode or any other light emitter and therefore have a large optical dust collection effect but can sufficiently suppress adhesion of foreign matter to the homogenizing optical system 24.

The illuminator 2 according to the present embodiment includes the light source apparatus 20, which provides the effects described above, the first light collection system 26, which the light that exits out of the light transmissive member 52 enters and which collects the light having entered the first light collection system 26, and the wavelength converter 40, which the light collected by the first light collection system 26 enters, whereby the amount of light outputted from the illuminator 2 can be increased.

The projector 1 according to the present embodiment includes the illuminator 2, which provides the effects described above, the light modulators 4B, 4G, and 4R, each of which modulates the light outputted from the illuminator 2 in accordance with image information to form image light, and the projection optical apparatus 6, which projects the image light outputted from the light modulator 43, the image light outputted from the light modulator 4G, and the image light outputted from the light modulator 4R, whereby a projector that outputs an increased amount of light can be provided.

The technical range of the present disclosure is not limited to that in the embodiment described above, and a variety of changes can be made to the embodiment to the extent that the changes do not depart from the substance of the present disclosure.

For example, the aforementioned embodiment has been described with reference to the case where the multi-lens array 51 forms the focal points F on the second surface 51b, and the multi-lens array 51 may instead form the focal points F in positions between the first surface 51a and the second surface 51b, that is, in the multi-lens array 51. Still instead, the multi-lens array 51 may form the focal points in positions between the second surface 51b of the multi-lens array 51 and the third surface 52c of the light transmissive member 52, that is, in the space S.

In the embodiment described above, the multi-lens array having the first multi-lens surface 56a and the second multi-lens surface 56b provided to surfaces of the single base 55, or the multi-lens array 51, which is what is called an integrated multi-lens array is used. In place of the configuration described above, a multi-lens array having the first multi-lens surface 56a provided to a surface of one base and the second multi-lens surface 56b provided to a surface of another base, what is called a separate-base multi-lens array may be used. Even in this case, the light transmissive member 52 may be disposed on the light exiting side of the second multi-lens surface 56b.

The method for bonding the light transmissive member 52 and the seal member 53 to each other and the method for bonding the multi-lens array 51 and the seal member 53 to each other are not necessarily any of the bonding methods used in the embodiment described above and can be an atomic diffusion bonding method.

The aforementioned embodiment has been described with reference to the fixed wavelength converter 40 configured not to be rotatable. The present disclosure is also applicable to a light source apparatus including a wavelength converter configured to be rotatable with a motor.

In addition, the specific descriptions of the shape, the number, the arrangement, the material, and other factors of the components of the light source apparatus, the illuminator, and the projector are not limited to those in the embodiment described above and can be changed as appropriate. The aforementioned embodiment has been described with reference to the case where the light source apparatus according to the present disclosure is incorporated in a projector using liquid crystal light valves, but not necessarily. The light source apparatus according to the present disclosure may be incorporated in a projector using a digital micromirror device as each of the light modulators. The projector may not include a plurality of light modulators and may instead include only one light modulator.

The aforementioned embodiment has been described with reference to the case where the light source apparatus according to the present disclosure is incorporated in a projector, but not necessarily. The light source apparatus according to the present disclosure may be used as a lighting apparatus, a headlight of an automobile, and other components.

A light source apparatus according to an aspect of the present disclosure may have the configuration below.

The light source apparatus according to the aspect of the present disclosure includes a light emitter that outputs light, a multi-lens array having a first surface on which the light outputted from the light emitter is incident and a second surface via which the light incident via the first surface exits, a light transmissive member having a third surface on which the light that exits via the second surface is incident and a fourth surface via which the light incident via the third surface exits, and a seal member that seals the space between the second surface and the third surface, and the multi-lens array forms a focal point which is located on the light exiting side with respect to the first surface and where the light that enters the multi-lens array is focused.

In the light source apparatus according to the aspect of the present disclosure, the multi-lens array may be formed of a base having the first surface and the second surface, the first surface may be provided with a first multi-lens surface, and the second surface may be provided with a second multi-lens surface.

In the light source apparatus according to the aspect of the present disclosure, the light transmissive member and the seal member may be bonded to each other by means of optical contact.

In the light source apparatus according to the aspect of the present disclosure, the multi-lens array and the seal member may be bonded to each other by means of optical contact.

In the light source apparatus according to the aspect of the present disclosure, the light transmissive member and the seal member may be bonded to each other via a plasma polymerization film.

In the light source apparatus according to the aspect of the present disclosure, the multi-lens array and the seal member may be bonded to each other via a plasma polymerization film.

In the light source apparatus according to the aspect of the present disclosure, the multi-lens array, the transmissive member, and the seal member may be made of quartz.

In the light source apparatus according to the aspect of the present disclosure, the light emitter may be formed of a laser device that outputs laser light as the light.

An illuminator according to another aspect of the present disclosure may have the configurations below.

The illuminator according to the other aspect of the present disclosure includes the light source apparatus according to the aspect of the present disclosure, a light collector that receives light that exits out of the transmissive member and collects the received light, and a diffuser that receives the light collected by the light collector.

A projector according to another aspect of the present disclosure may have the configurations below.

The projector according to the other aspect of the present disclosure includes the light source apparatus according to the aspect of the present disclosure, a light modulator that modulates the light outputted from the light source apparatus in accordance with image information to form image light, and a projection optical apparatus that projects the image light outputted from the light modulator.

What is claimed is:

1. A light source apparatus comprising:
a light emitter that outputs light;
a multi-lens array having a first surface on which the light outputted from the light emitter is incident and a second surface via which the light incident via the first surface exits;
a light transmissive member having a third surface on which the light that exits via the second surface is incident and a fourth surface via which the light incident via the third surface exits; and
a seal member that seals a space between the second surface and the third surface,
wherein the multi-lens array forms a focal point which is located on a light exiting side with respect to the first surface and where the light that enters the multi-lens array is focused.

2. The light source apparatus according to claim 1,
wherein the multi-lens array is formed of a base having the first surface and the second surface, and
the first surface is provided with a first multi-lens surface, and the second surface is provided with a second multi-lens surface.

3. The light source apparatus according to claim 1, wherein the light transmissive member and the seal member are bonded to each other by means of optical contact.

4. The light source apparatus according to claim 1, wherein the multi-lens array and the seal member are bonded to each other by means of optical contact.

5. The light source apparatus according to claim 1, wherein the light transmissive member and the seal member are bonded to each other via a plasma polymerization film.

6. The light source apparatus according to claim 1, wherein the multi-lens array and the seal member are bonded to each other via a plasma polymerization film.

7. The light source apparatus according to claim 1, wherein the multi-lens array, the transmissive member, and the seal member are made of quartz.

8. The light source apparatus according to claim 1, wherein the light emitter is formed of a laser device that outputs laser light as the light.

9. An illuminator comprising:
the light source apparatus according to claim 1;
a light collector that receives light that exits out of the transmissive member and collects the received light; and
a diffuser that receives the light collected by the light collector.

10. A projector comprising:
the light source apparatus according to claim 1;
a light modulator that modulates light outputted from the light source apparatus in accordance with image information to form image light; and
a projection optical apparatus that projects the image light outputted from the light modulator.
